(19) United States
(12) Patent Application Publication
(10) Pub. No.: US 2007/0002289 A1
(43) Pub. Date: Jan. 4, 2007

(54) Image projecting apparatus

(76) Inventor: Pil-yong Oh, Suwon-si (KR)

Correspondence Address: STANZIONE & KIM, LLP, 919 18TH STREET, N.W., SUITE 440, WASHINGTON, DC, 20006, US

(21) Appl. No.: 11/384,544

(22) Filed: Mar. 21, 2006

(30) Foreign Application Priority Data
Jun. 29, 2005 (KR) 2005-57076

(51) Int. Cl. G03B 21/22; G03B 21/14

(52) U.S. Cl. 353/119

(57) ABSTRACT

An image projecting apparatus includes a housing in which at least one vibration generating component is disposed, a vibration-proof supporting bracket coupled to a side of the housing to support the housing against an installation surface to absorb vibrations generated by the at least one vibration generating component, and a vibration guide part to couple the vibration-proof supporting bracket with the housing at a position that corresponds to the at least one vibration generating component, thereby transferring the vibrations generated by the at least one vibration generating component to the vibration-proof supporting bracket. Thus, the image projecting apparatus has a simplified structure which effectively reduces vibration noise of vibration generating components disposed therein.

### CROSS-REFERENCE TO RELATED APPLICATIONS

This application claims the benefit of Korean Patent Application No. 2005-57076, filed on Jun. 29, 2005, in the Korean Intellectual Property Office, which is hereby incorporated by reference in its entirety for all purposes as if fully set forth herein.

### BACKGROUND OF THE INVENTION

1. Field of the Invention

The present general inventive concept relates to an image projecting apparatus, and more particularly, to an image projecting apparatus having a simplified structure which effectively reduces vibration noise of vibration generating components in the image projecting apparatus.

2. Description of the Related Art

Generally, an image projecting apparatus includes an optical system having display elements, and a light source for supplying light to the optical system. The image projecting apparatus enlarges an image formed by the display elements to project the image on a screen.

Since image projecting apparatuses have become small and light, the rate at which heat generated inside of the image projecting apparatus is quickly discharged outside of the image projecting apparatus has become more important.

A conventional image projecting apparatus includes a cooling device for cooling various heat generating components such as a light source and a color wheel (refer to Korean Utility Model No. 0342881) which generate heat during operation.

Additionally, Korean Patent First Publication No. 2002-8902 describes a lamp fan for cooling a lamp assembly directly using outside air.

However, the color wheel and the cooling fan generate vibration during operation, thereby generating noise. In an attempt to solve this problem, Korean Patent First Publication No. 2005-33339 describes a vibration-proof member for reducing the vibration and the noise generated by the cooling fan. Korean Utility Model No. 0342881 describes first and second vibration-proof members for reducing the vibration and the noise generated by rotation of the color wheel.

Therefore, in order to reduce the vibration noise, the respective vibration-proof members corresponding to the vibration generating components including the cooling fan and the color wheel should be manufactured separately, thereby increasing the cost of manufacturing. Further, the plurality of vibration-proof members corresponding to the vibration generating components are coupled to each of the respective vibration generating components and are also coupled to the image projecting apparatus such that the working man power increases.

### SUMMARY OF THE INVENTION

The present general inventive concept provides an image projecting apparatus having a simplified structure which effectively reduces vibration noise of vibration generating components disposed therein.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image projecting apparatus comprising a housing in which at least one vibration generating component is disposed; a vibration-proof supporting bracket coupled to a side of the housing to support the housing against an installation surface and to absorb vibrations generated by the at least one vibration generating component, and at least one vibration guide part disposed at a position of the vibration-proof supporting bracket that corresponds to the at least one vibration generating component to couple the vibration-proof supporting bracket with the housing, thereby transferring the vibrations generated by the at least one vibration generating component to the vibration-proof supporting bracket.

The at least one vibration guide part may comprise at least one screw to fasten the housing to the vibration-proof supporting bracket in the position that corresponds to the at least one vibration generating component.

The image projecting apparatus may further comprise at least one pass through hole disposed in the vibration-proof supporting bracket through which the at least one screw is inserted in the vibration-proof supporting bracket; and at least one fastening hole disposed in the housing to be connected with the at least one pass through hole.

The housing may comprise a lower case formed with the at least one fastening hole to correspond to the at least one vibration generating component and coupled with the vibration-proof supporting bracket on an outside thereof; and an upper case coupled to an upper side of the lower case.

The at least one vibration generating component may comprise at least one of a cooling fan and a color wheel which are disposed at the lower case.

The vibration-proof supporting bracket may comprise one of a stone material or a metallic material.

The foregoing and/or other aspects of the present general inventive concept are also achieved by providing an image projecting apparatus, comprising a housing, a plurality of vibrating components disposed in the housing, and a vibration proof member disposed on a surface of the housing and coupled to each of the plurality of vibrating components through the housing.

The foregoing and/or other aspects of the present general inventive concept are also achieved by providing an image projecting apparatus, comprising a housing, a plurality of vibrating components disposed in the housing, and a common vibration prevention unit to prevent vibrations from the plurality of vibrating components from generating noise and having a plurality of corresponding coupling points at which the common vibration prevention unit is coupled to both the plurality of corresponding vibrating components and the housing.

The foregoing and/or other aspects of the general inventive concept are also achieved by providing an image projecting system comprising an installation device including a receiving frame to accommodate the image projecting apparatus (described above), and a connecting part coupled to the receiving frame on a first side thereof and coupled to a ceiling surface on a second side thereof.

The foregoing and/or other aspects of the present general inventive concept are also achieved by providing an installation device usable with an image projecting apparatus having a lower case in which at least one vibration generating component is disposed and an upper case coupled to an upper side of the lower case to dispose the image projecting apparatus on an installation surface, the device comprising a vibration-proof supporting bracket coupled to an outside surface of the lower case to absorb vibrations generated by the at least one vibration generating component, at least one vibration guide part to couple the vibration-proof supporting bracket with the lower case at a position that corresponds to the at least one vibration generating component, thereby transferring the vibrations generated by the at least one vibration generating component into the vibration-proof supporting bracket, and a connecting unit to connect the vibration-proof supporting bracket and the installation surface.

The connecting unit may comprise a coupling bracket coupled to the vibration-proof supporting bracket, and a connecting part to connect the coupling bracket with the installation surface.

The foregoing and/or other aspects of the present general inventive concept are also achieved by providing an image projecting apparatus comprising a lower case in which a plurality of vibration generating components are disposed, an upper case coupled to an upper side of the lower case, a vibration-proof supporting bracket coupled to an outside of the lower case to absorb vibrations generated by the plurality of vibration generating components, a vibration guide part to couple the vibration-proof supporting bracket with the lower case at positions that correspond to the plurality of vibration generating components, thereby transferring the vibrations generated by the plurality of vibration generating components into the vibration-proof supporting bracket, and an installation device having a coupling bracket coupled to the vibration-proof supporting bracket, and a connecting part to connect the coupling bracket with an installation surface.

The coupling bracket may comprise a first coupling bracket coupled to the vibration-proof supporting bracket, and a second coupling bracket coupled to the first coupling bracket at a first side thereof and coupled to the connecting part at a second side thereof.

The image projecting apparatus may further comprise a wall bracket provided between the installation surface and the connecting part and to couple the connecting part to the installation surface.

The foregoing and/or other aspects of the present general inventive concept are also achieved by providing an image projecting system assembly, comprising: an image projecting apparatus including a housing, a plurality of vibrating components disposed in the housing, and a vibration proof member disposed on a surface of the housing and coupled to each of the plurality of vibrating components through the housing; and an installation device to support the image projecting apparatus by the vibration proof member and having a connecting part to connect to an installation surface.

Additional features of the general inventive concept will be set forth in the description which follows, and in part will be apparent from the description, or may be learned by practice of the general inventive concept.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating an image projecting apparatus according to an embodiment of the present general inventive concept.

FIG. 2 is a plane view illustrating the image projecting apparatus of FIG. 1 in a state in which an upper case of the image projecting apparatus is separated therefrom according to an embodiment of the present general inventive concept.

FIGS. 3 and 4 are perspective views illustrating the image projecting apparatus of FIG. 1 in a state in which a color wheel assembly and a fourth cooling fan are installed therein according to an embodiment of the present general inventive concept.

FIG. 5 is an exploded perspective view illustrating a housing and a supporting bracket of the image projecting apparatus of FIG. 1 according to an embodiment of the present general inventive concept.

FIG. 6 is a perspective view illustrating the housing and the supporting bracket of the image projecting apparatus of FIG. 1 in a coupled state according to an embodiment of the present general inventive concept.

FIG. 7 is a cross-sectional view illustrating a first cooling fan installed in the image forming apparatus of FIG. 1 according to an embodiment of the present general inventive concept.

FIG. 8 is a cross-sectional view illustrating the color wheel assembly of the image forming apparatus of FIG. 1 according to an embodiment of the present general inventive concept.

FIG. 9 illustrates the image projecting apparatus of FIG. 1 disposed at an installing device according to an embodiment of the present general inventive concept.

FIG. 10 illustrates an image projecting apparatus suspended from a ceiling by an installation device according to another embodiment of the present general inventive concept.

FIG. 11 illustrates an image projecting apparatus suspended from a wall surface by an installation device according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

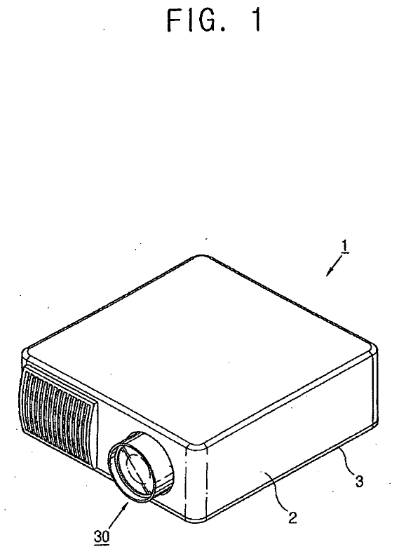

Referring to FIG. 1, an image projecting apparatus according to an embodiment of the present general inventive concept includes a housing 1 having a lower case 3 on which various components are disposed and an upper case 2 coupled to an upper side of the lower case 3.

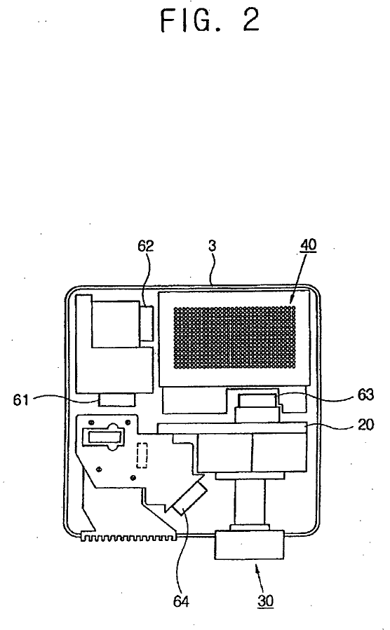

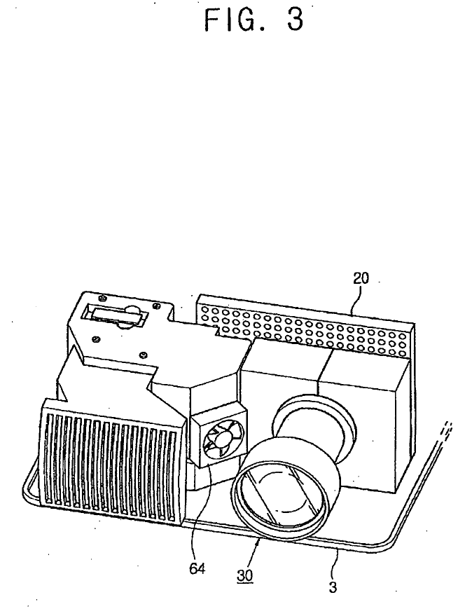

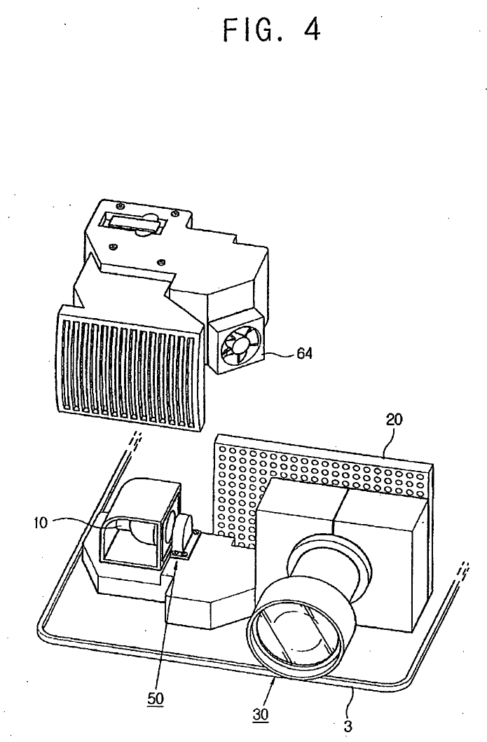

Referring to FIGS. 2 to 4, the image projecting apparatus includes a light source part 10 provided in the housing 1 to generate light, a display element part 20 (e.g., a DMD panel part) to form an image using the light from the light source part 10, a projecting part 30 to enlarge and project the image that is formed and projected by the display element part 20 to a screen (not shown), and a driving part 40 electrically connected with the display element part 20 to drive the display element part 20 to form the image.

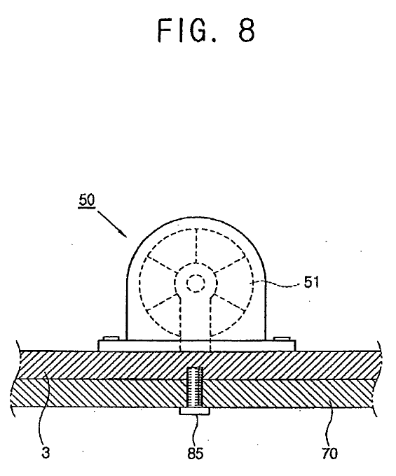

The image projecting apparatus further includes a color wheel assembly 50 provided in the housing 1 and having a color wheel 51 (see FIG. 8) to separate the light emitted from the light source part 10 into various color beams, for example, Red, Green, and Blue, a light tunnel assembly (not shown) to shape a beam of the light passing through the color wheel 51 into an identical shape with respect to a plane surface of the display element part 20, and a light pathway converting assembly (not shown) to allow the light passing through the light tunnel assembly (not shown) to face the display element part 20.

A plurality of cooling fans are provided in the housing 1 to cool heat generating components including the light source part 10, the color wheel 51, the driving part 40, and/or the display element part 20.

The plurality of cooling fans may include a first cooling fan 61 to cool the light source part 10 by ventilating air toward the light source part 10, a second cooling fan 62 to cool the driving part 40 by discharging air drawn away from the driving part outside of the housing 1, a third cooling fan 63 to cool the display element part 20 by ventilating the air toward the display element part 20, and a fourth cooling fan 64 to cool the color wheel 51 by ventilating the air toward the color wheel 51.

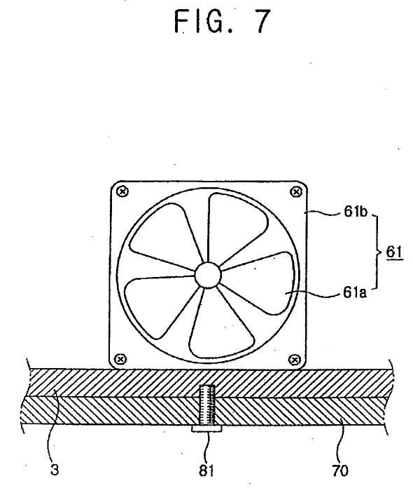

Herein, the first, second, third, and fourth cooling fans 61, 62, 63, and 64 and the color wheel 51 may be vibration generating components that generate vibrations during operation of the image projecting apparatus. The first, second, third, and fourth cooling fans 61, 62, 63, and 64, respectively, include a blade to rotate and a fan case to rotatably support the blade. For example, referring to FIG. 7, the first cooling fan 61 includes a blade 61a to rotate and a fan case 61b to rotatably support the blade 61a.

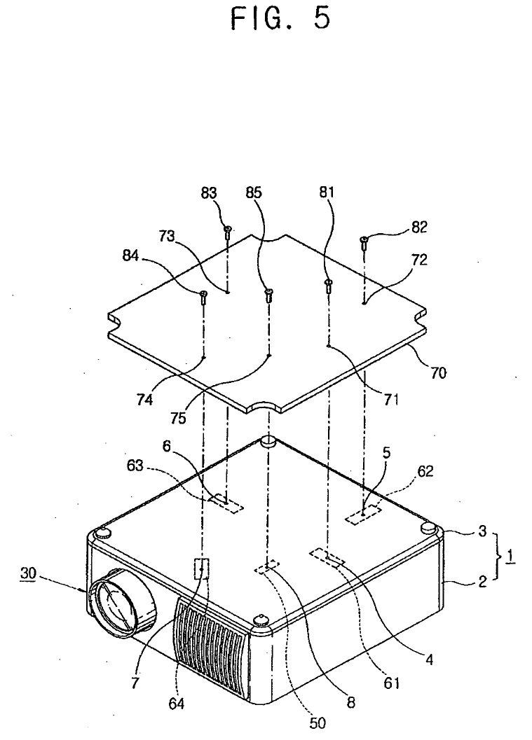

Referring to FIGS. 5 to 7, the image projecting apparatus according to the present embodiment further includes a vibration-proof supporting bracket 70 coupled to the lower case 3 to support the housing 1 against a predetermined installation surface and absorbing the vibrations generated by the vibration generating components, and a plurality of fastener elements to couple the vibration-proof supporting bracket 70 to the lower case 3 and to transfer the vibrations generated by the vibration generating components to the vibration-proof supporting bracket 70. The plurality of fastener elements may include first, second, third, fourth, and fifth fastener elements 81, 82, 83, 84, and 85, respectively. For example, the fastener elements may be screws or bolts. Other types of fastener elements may also be used with the various embodiments of the present general inventive concept. The fastener elements may be able to transfer the vibrations.

The vibrations generated by the vibration generating components is transferred through the lower case 3 because the vibration-proof supporting bracket 70 contacts an outside of the lower case 3. The vibration-proof supporting bracket 70 may be a metallic or stone material of which rigidity and weight are large so as to absorb the noise caused by the vibrations of the vibration generating components.

The first, second, third, fourth, and fifth fastener elements 81, 82, 83, 84, and 85 are fastened to first, second, third, fourth, and fifth fastening holes 4, 5, 6, 7, and 8 formed in the lower case 3 at positions that correspond to the first, second, third, and fourth cooling fans 61, 62, 63, and 64, and the color wheel 51, respectively, by being inserted through first, second, third, fourth, and fifth pass through holes 71, 72, 73, 74, and 75 formed in the vibration-proof supporting bracket 70 at positions that correspond to the first, second, third, and fourth cooling fans 61, 62, 63, and 64, and the color wheel 51, respectively.

Therefore, the noise generated by the vibration of the vibration generating components is transferred to the vibration-proof supporting bracket 70 through the first, second, third, fourth, and fifth screws 81, 82, 83, 84, and 85 as the first, second, third, fourth, and fifth fastener elements 81, 82, 83, 84, and 85 are fastened at the positions corresponding to the first, second, third, and fourth cooling fans 61, 62, 63, and 64, and the color wheel 51, respectively.

A method of reducing the noise caused by the vibrations of the vibration generating components in the image projecting apparatus having the above-described structure is described below.

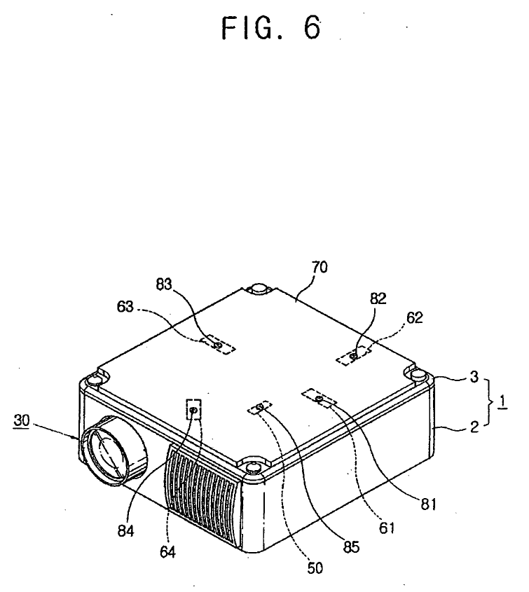

Referring to FIGS. 5 and 6, the lower case 3 is disposed at an upper side of the image projecting apparatus (i.e., the image projecting apparatus is inverted), and the upper case 2 is disposed at a lower side thereof. The vibration-proof supporting bracket 70 is then placed in contact with the outside of the lower case 3. Accordingly, the first, second, third, fourth, and fifth pass through holes 71, 72, 73, 74, and 75 of the vibration-proof supporting bracket 70 are aligned with the first, second, third, fourth, and fifth fastening holes 4, 5, 6, 7, and 8 formed in the lower case 3. The first, second, third, fourth, and fifth fastener elements 81, 82, 83, 84, and 85 are fastened to the first, second, third, fourth, and fifth fastening holes 4, 5, 6, 7, and 8 by being inserted through the first, second, third, fourth, and fifth pass through holes 71, 72, 73, 74, and 75. Accordingly, the vibration-proof supporting bracket 70 is coupled to the lower case 3. Although the present embodiment describes four cooling fans, five fastening holes, five pass through holes, and five fastener elements, it should be understood that other numbers and arrangements of these elements may be used with the embodiments of the present general inventive concept, and the above description is therefore not intended to limit the scope thereof.

The vibration-proof supporting bracket 70 is placed in contact with the installation surface such as a table (or other surface) by overturning (i.e., re-inverting) the housing 1 so that the upper case 2 is again disposed on the upper side of the image projecting apparatus and the lower case 3 is disposed on the lower side thereof. Therefore, the vibration-proof supporting bracket 70 supports the housing 1 of the image projecting apparatus against the installation surface such as the table (or other surface).

The first, second, third, and fourth cooling fans 61, 62, 63, and 64, and the color wheel 51 are the vibration generating components during operation of the image projecting apparatus, and the noise is generated from the first, second, third, and fourth cooling fans 61, 62, 63, and 64, and the color wheel 51. The noise is transferred to the vibration-proof supporting bracket 70 through the first, second, third, fourth, and fifth fastener elements 81, 82, 83, 84, and 85 (e.g., screws) that are correspondingly fastened to the first, second, third, and fourth cooling fans 61, 62, 63, and 64, and the color wheel 51, respectively, so that the vibration-proof supporting bracket 70 absorbs the noise and the vibrations, thereby preventing noise from being generated according to the vibrations of the vibration generating components.

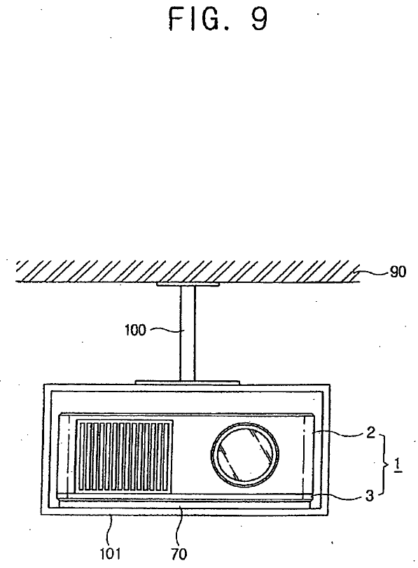

FIG. 9 illustrates the image projecting apparatus of FIGS. 1 to 6 disposed on an installing device according to an embodiment of the present general inventive concept.

The image projecting apparatus may be provided in the installation surface such as the table (or other surface), alternatively, the image projecting apparatus may be suspended from a ceiling 90 using an installation device as illustrated in FIG. 9.

The installation device includes a connecting part 100 coupled to the ceiling 90, and a receiving frame 101 to accommodate the image projecting apparatus therein according to the present embodiment.

If the housing 1 of the image projecting apparatus which is coupled with the vibration-proof supporting bracket 70 on the lower case 3 is accommodated in the receiving frame 102, the vibration-proof supporting bracket 70 is provided at a bottom inner surface of the receiving frame 101

The vibrations generated by the first, second, third, and fourth cooling fans 61, 62, 63, and 64, and the color wheel 51, which are the vibration generating components, are transferred and absorbed into the vibration-proof supporting bracket 70 through the first, second, third, fourth, and fifth fastener elements 81, 82, 83, 84, and 85 that are correspondingly fastened to the first, second, third, and fourth cooling fans 61, 62, 63, and 64, and the color wheel 51, respectively, so that the vibrations generated by the vibration generating components accommodated in the housing 1 are transferred to the receiving frame 101, thereby preventing noise from being generated.

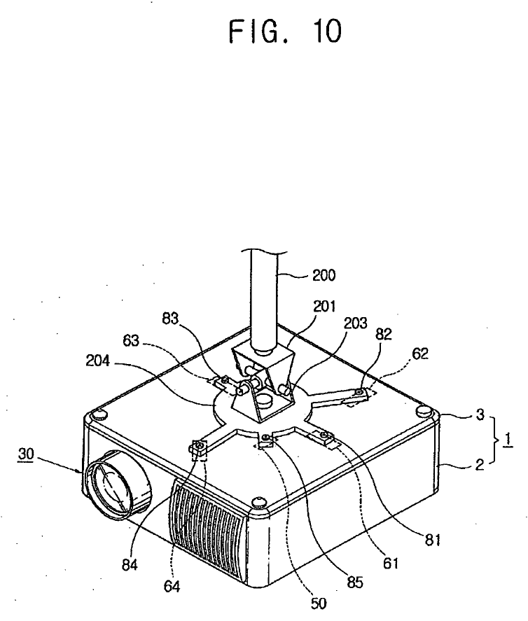

FIG. 10 illustrates an image projecting apparatus suspended from a ceiling (not shown) by an-installation device according to another embodiment of the present general inventive concept. It should be understood that some of the elements of the image projecting apparatus of FIG. 10 are the same or similar to some of the elements of the image forming apparatus of previous embodiment(s). Accordingly, the same reference numbers will be used to refer to these elements. Referring to FIG. 10, the image projecting apparatus includes a housing 1 having a lower case 3 disposed at an upper side thereof and an upper case 2 disposed at a lower side thereof by inverting the image projecting apparatus, and the image projecting apparatus is suspended from the ceiling by the installation device.

Even though the inverted image projecting apparatus is suspended from the ceiling, an upright mode and an inverted reversal mode is provided in the image projecting apparatus, so that the image can be displayed normally on a screen (i.e., right side up).

The installation device includes a connecting part 200 disposed at an installation surface such as the ceiling, and first and second coupling brackets 203 and 201 provided between the connecting part 200 and the housing 1 of the image projecting apparatus.

A vibration-proof supporting bracket 204 is provided between the lower case 3 of the housing 1 and the first coupling bracket 203 of the installation device using first, second, third, fourth, and fifth fastener elements (e.g., screws or bolts) 81, 82, 83, 84, and 85.

The vibration-proof supporting bracket 204 may be a metallic or stone material having a large rigidity and weight so as to prevent the noise from being by the vibrations of the vibration generating components. Other rigid materials may also be used with the embodiments of the present general inventive concept. The vibration-proof supporting bracket 204 is fastened to the outside of the lower case 3 by the first, second, third, fourth, and fifth fastener elements 81, 82, 83, 84, and 85.

The first, second, third, fourth, and fifth fastener elements 81, 82, 83, 84, and 85 correspond to first, second, third, and fourth cooling fans 61, 62, 63, and 64 and a color wheel 51 which are disposed in the housing 1.

Therefore, the vibrations generated by the first, second, third, and fourth cooling fans 61, 62, 63, and 64, and the color wheel 51 are transferred and absorbed into the vibration-proof supporting bracket 204 through the first, second, third, fourth, and fifth fastener elements 81, 82, 83, 84, and 85 that are correspondingly fastened to the first, second, third, and fourth cooling fans 61, 62, 63, and 64, and the color wheel 51, respectively, thereby preventing noise from being generated according to the vibrations.

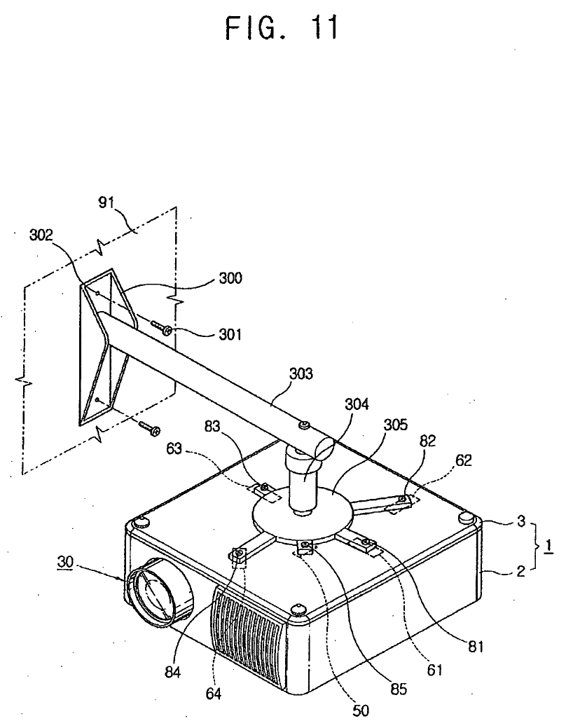

FIG. 11 illustrates an image projecting apparatus disposed at a wall surface 91 by an installation device according to another embodiment of the present general inventive concept. It should be understood that some of the elements of the image projecting apparatus of FIG. 11 are the same or similar to some of the elements of the image forming apparatus of previous embodiment(s). Accordingly, the same reference numbers will be used to refer to these elements. Referring to FIG. 11, the image projecting apparatus includes a housing 1 having a lower case 3 disposed at an upper side thereof and an upper case 2 disposed at a lower side thereof by inverting the image projecting apparatus, and suspending the image projecting apparatus from the wall surface 91 using the installation device.

The installation device includes a wall bracket 300 installed on the wall surface 91 using bracket fasteners 301 (e.g., bolts or screws), a connecting part 303 connecting the wall bracket 300 and the housing 1 of the image projecting apparatus, and a coupling bracket 304 coupled to the connecting part 303 on a first side thereof and to a vibration-proof supporting bracket 305 on a second side thereof.

The vibration-proof supporting bracket 305 and first, second, third, fourth, and fifth fastener elements 81, 82, 83, 84, and 85 (e.g., screws or bolts) are provided between the lower case 3 of the housing 1 and the coupling bracket 304 of the installation device.

The vibration-proof supporting bracket 305 may be a metallic or stone material having a large rigidity and weight so as to prevent the noise from being generated by the vibrations of the vibration generating components. The vibration-proof supporting bracket 305 is fastened to the lower case 3 by the first, second, third, fourth, and fifth fastener elements 81, 82, 83, 84, and 85.

The first, second, third, fourth, and fifth screws 81, 82, 83, 84, and 85 correspond to first, second, third, and fourth cooling fans 61, 62, 63, and 64 and a color wheel 51 which are disposed in the housing 1.

The vibrations generated by the first, second, third, and fourth cooling fans 61, 62, 63, and 64, and the color wheel 51 are transferred and absorbed into the vibration-proof supporting bracket 305 through the first, second, third, fourth, and fifth fastener elements 81, 82, 83, 84, and 85 that are correspondingly fastened to the first, second, third, and fourth cooling fans 61, 62, 63, and 64, and the color wheel 51, respectively, thereby preventing noise from being generated according to the vibrations.

The image projecting apparatus of the various embodiments of the present general inventive concept may operate in the upright mode in which the vibration-proof supporting bracket (70, 204, or 305) is disposed on the installation surface such as the table, the receiving frame 101 of FIG. 9, etc. such that the housing 1 is in an upright position to project an image right side up on the screen. Additionally, the image projecting apparatus may operate in the inverted reversal mode in which the vibration-proof supporting bracket (70, 204, or 305) can be connected to coupling brackets (201, 203, or 304) and suspended from the ceiling 90 or from the wall surface 91 such that the housing 1 is in an inverted position to project an image right side up on the screen.

In view of the various embodiments of the present general inventive concept, a vibration-proof supporting bracket is coupled to a lower case of a housing, and a plurality of fastener elements (e.g., screws or bolts) are correspondingly fastened to vibration generation components in the housing, so that vibrations generated by the vibration generation components are guided into the vibration-proof supporting bracket by the fastener elements and the vibration-proof supporting bracket absorbs the vibrations, thereby preventing noise from being generated.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image projecting apparatus, comprising:
a housing having at least one vibration generating component disposed therein;
a vibration-proof supporting bracket coupled to a side of the housing to absorb vibrations generated by the at least one vibration generating component; and
at least one vibration guide part disposed at a position of the vibration-proof supporting bracket that corresponds to the at least one vibration generating component to couple the vibration-proof supporting bracket to the housing, thereby transferring the vibrations generated by the at least one vibration generating component to the vibration-proof supporting bracket.

2. The image projecting apparatus according to claim 1, wherein the at least one vibration guide part comprises at least one screw to fasten the housing to the vibration-proof supporting bracket in the position that corresponds to the at least one vibration generating component.

3. The image projecting apparatus according to claim 2, further comprising:
at least one pass through hole disposed in the vibration-proof supporting bracket through which the at least one screw is inserted in the vibration-proof supporting bracket; and
at least one fastening hole disposed in the housing to be connected with the at least one pass through hole.

4. The image projecting apparatus according to claim 3, wherein the housing comprises:
a lower case formed with the at least one fastening hole to correspond to the at least one vibration generating component and coupled with the vibration-proof supporting bracket on an outside surface thereof; and
an upper case coupled to an upper side of the lower case.

5. The image projecting apparatus according to claim 4, wherein the at least one vibration generating component comprises at least one of a cooling fan and a color wheel which are disposed at the lower case.

6. The image projecting apparatus according to claim 1, wherein the vibration-proof supporting bracket comprises one of a stone material and a metallic material.

7. An image projecting apparatus, comprising:
a housing;
a plurality of vibrating components disposed in the housing; and
a vibration proof member disposed on a surface of the housing and coupled to each of the plurality of vibrating components through the housing.

8. The image projecting apparatus according to claim 7, wherein the plurality of vibrating components comprise one or more of a cooling fan and a color wheel.

9. The image projecting apparatus according to claim 7, wherein the vibration proof member comprises a vibration proof bracket coupled to one of a lower and upper part of the housing.

10. The image projecting apparatus according to claim 9, wherein the vibration proof bracket is disposed on the lower part of the housing, and the apparatus is operable in a normal mode in which the vibration proof bracket is disposed on a lower side of the housing and an inverted mode in which the vibration proof bracket is disposed on an upper side of the housing.

11. The image projecting apparatus according to claim 9, wherein:
the housing includes a plurality of fastener holes that correspond to positions of the plurality of vibrating components; and
the vibration proof bracket comprises a plurality of through holes that correspond the plurality of fastener holes in the housing such that a plurality of fasteners couple the vibration proof bracket to the housing at the positions that correspond to the plurality of vibrating components.

12. The image projecting apparatus according to claim 11, wherein the plurality of vibrating components are coupled to a side of the housing opposite to a side in which the fasteners are fastened.

13. The image projecting apparatus according to claim 11, wherein the fasteners comprise one or more of screws and bolts.

14. The image projecting apparatus according to claim 7, further comprising:
a plurality of fastener elements to couple the vibration proof member to the housing and to guide vibrations from the plurality of vibrating components into the vibration proof member.

15. An image projecting apparatus, comprising:
a housing;
a plurality of vibrating components disposed in the housing; and
a common vibration prevention unit to prevent vibrations from the plurality of vibrating components from generating noise and having a plurality of corresponding coupling points at which the common vibration prevention unit is coupled to both the plurality of corresponding vibrating components and the housing.

16. An image projecting system, comprising:
an image projecting apparatus, including:
a housing having at least one vibration generating component disposed therein,
a vibration-proof supporting bracket coupled to a side of the housing to absorb vibrations generated by the at least one vibration generating component, and
at least one vibration guide part disposed at a position of the vibration-proof supporting bracket that corresponds to the at least one vibration generating component to couple the vibration-proof supporting bracket to the housing, thereby transferring the vibrations generated by the vibration generating component to the vibration-proof supporting bracket; and
an installation device, including:
a receiving frame to accommodate the image projecting apparatus therein, and
a connecting part coupled to the receiving frame on a first side thereof and coupled to a ceiling surface on a second side thereof.

17. An installation device usable with an image projecting apparatus having a lower case in which at least one vibration generating component is disposed and an upper case coupled to an upper side of the lower case to dispose the image projecting apparatus on an installation surface, the device comprising:
a vibration-proof supporting bracket coupled to an outside surface of the lower case to absorb vibrations generated by the at least one vibration generating component;
at least one vibration guide part to couple the vibration-proof supporting bracket with the lower case at a position that corresponds to the at least one vibration generating component, thereby transferring the vibrations generated by the at least one vibration generating component into the vibration-proof supporting bracket; and
a connecting unit to connect the vibration-proof supporting bracket and the installation surface.

18. The installation device according to claim 17, wherein the connecting unit comprises:
a coupling bracket coupled to the vibration-proof supporting bracket; and
a connecting part to connect the coupling bracket with the installation surface.

19. An image projecting apparatus, comprising:
a lower case in which a plurality of vibration generating components are disposed;
an upper case coupled to an upper side of the lower case;
a vibration-proof supporting bracket coupled to an outside of the lower case to absorb vibrations generated by the plurality of vibration generating components;
a vibration guide part to couple the vibration-proof supporting bracket with the lower case at positions that correspond to the plurality of vibration generating components, thereby transferring the vibrations generated by the plurality of vibration generating components into the vibration-proof supporting bracket; and
an installation device having a coupling bracket coupled to the vibration-proof supporting bracket, and a connecting part to connect the coupling bracket with an installation surface.

20. The image projecting apparatus according to claim 19, wherein the coupling bracket comprises:
a first coupling bracket coupled to the vibration-proof supporting bracket; and
a second coupling bracket coupled to the first coupling bracket on a first side thereof and coupled to the connecting part on a second side thereof.

21. The image projecting apparatus according to claim 20, further comprising:
a wall bracket provided between the installation surface and the connecting part and to couple the connecting part to the installation surface.

22. An image projecting system assembly, comprising:
an image projecting apparatus, including:
a housing,
a plurality of vibrating components disposed in the housing, and
a vibration proof member disposed on a surface of the housing and coupled to each of the plurality of vibrating components through the housing; and
an installation device to support the image projecting apparatus by the vibration proof member and having a connecting part to connect to an installation surface.

23. The assembly according to claim 22, wherein the installation device suspends the image projecting apparatus by the vibration proof member from one of a ceiling and a vertical wall.

24. The assembly according to claim 22, wherein the installation device is suspended from a ceiling by the connecting part.

25. The assembly according to claim 24, wherein the installation device comprises:
a receiving frame having a support platform disposed on an inner surface thereof to support the image projecting apparatus such that the receiving frame encloses the image projecting apparatus;
a first coupling part to couple the receiving frame to the connecting part; and
a second coupling part to couple the connecting part to the ceiling.

26. The assembly according to claim 22, wherein the installation device is suspended from a vertical wall.

27. The assembly according to claim 26, wherein the installation device comprises:
a wall bracket to couple the connecting part to a mounting portion on the wall in a horizontal direction; and
at least one coupling bracket to couple the connecting part to the vibration proof member.
